(19) United States
(12) Patent Application Publication
(10) Pub. No.: US 2021/0061972 A1
(43) Pub. Date: Mar. 4, 2021

(54) PLASTIC DEPOLYMERIZATION USING FLUORINATED ALUMINA

(71) Applicant: Basell Poliolefine Italia S.r.l., Milan (IT)

(72) Inventors: Sandor Nagy, Seabrook, TX (US); Christopher D. Smith, Kingwood, TX (US); Xueyong Yang, Bellaire, TX (US); Daniel F. White, Houston, TX (US); Sheri E. Davis, Baytown, TX (US); Shahram Mihan, Bad Soden (DE); Volker Fraaije, Frankfurt am Main (DE)

(73) Assignee: Basell Poliolefine Italia S.r.l., Milan (IT)

(21) Appl. No.: 17/001,832

(22) Filed: Aug. 25, 2020

Related U.S. Application Data
(60) Provisional application No. 62/893,398, filed on Aug. 29, 2019.

(51) Int. Cl. C08J 11/16; B01J 27/125; C10G 1/10

(52) U.S. Cl. CPC C08J 11/16; B01J 27/125; C10G 1/10; C10G 2400/20; C08J 2323/12; C10G 2300/1003; C08J 2323/06

(57) ABSTRACT

A method of depolymerizing plastics using a fluorinated alumina catalyst is described herein. The method reduces the energy required for the depolymerization process while achieving improved depolymerization results.

### PRIOR RELATED APPLICATIONS

This application claims the benefit of priority to U.S. Provisional Application No. 62/893,398 filed Aug. 29, 2019, which is incorporated here by reference in its entirety.

### FEDERALLY SPONSORED RESEARCH STATEMENT

Not applicable.

### FIELD OF THE DISCLOSURE

This disclosure relates to methods for depolymerizing plastic feedstock, and more particularly to methods for depolymerizing plastic feedstock in the presence of fluorinated alumina in order to reduce onset temperature and reaction half time.

### BACKGROUND OF THE DISCLOSURE

Plastics are inexpensive and durable materials, which can be used to manufacture a variety of products that find use in a wide range of applications, so that the production of plastics has increased dramatically over the last decades. Due to the durability of the polymers involved in plastic production, an increasing amount of plastics are filling up landfill sites and occupying natural habitats worldwide, resulting in environmental problems. Even degradable and biodegradable plastics may persist for decades depending on local environmental factors, like levels of ultraviolet light exposure, temperature, presence of suitable microorganisms and other factors.

Currently plastic recycling primarily includes mechanical recycling and chemical recycling. Globally speaking, mechanical recycling is the most used method for new uses of plastics, and through this method, plastics are mechanically transformed without changing their chemical structure, so they can be used to produce new materials. Typical mechanical recycling steps include collecting plastic wastes; sorting plastic wastes into different types of plastics and colors; packaging plastics by pressing or milling plastics; washing and drying the plastics; reprocessing the plastics into pellets by agglutinating, extruding and cooling the plastics; and finally recycled raw materials are obtained. This is the most widely used technology for the polyolefins polyethylene (PE) and polypropylene (PP).

Chemical recycling, on the other hand, reprocesses plastics and modify their structure so that they can be used as raw material for different industries or as a basic input or feed stock for manufacturing new plastic products. Chemical recycling typically includes the steps of collecting plastics, followed by heating the plastics to break down the polymers (thus depolymerization). The resulting monomers may then be used to re-manufacture plastic or to make other synthetic chemicals.

In practice, different types of plastic wastes are collected together, so that plastic bales contain a mixture of different plastics, the composition of which may vary from source to source, and the proportions of which may vary from bale to bale. This is particularly troublesome for chemical recycling because the mixture of different plastics makes it difficult to control the heating process, resulting in high cost of energy required during heating.

Also, conventional chemical recycling processes tend to generate high amount of alpha-olefin, paraffin, and C6-C8 aromatics, and low amount of the more desirable low molecular weight content (C2-C8), therefore further processing is required for recycling purposes.

### SUMMARY OF THE DISCLOSURE

The present disclosure is a new use of fluorinated alumina as a catalyst in the depolymerization process of polyolefin. The use of fluorinated alumina reduces onset temperature and reaction half time for depolymerization.

One embodiment provides a method for depolymerizing a plastic feedstock. The method comprising the steps of introducing a feedstock that of plastic, mixing the feedstock of plastic with a catalyst to obtain a reactant mixture, and heating the reactant mixture to obtain a product, wherein the catalyst is fluorinated alumina.

### DESCRIPTION OF EMBODIMENTS OF THE DISCLOSURE

As used herein, “fluorinated alumina” means the product of gamma-alumina impregnated with ammonium fluoride (NH₄F), in order to get a fluorine loading between 0 and 20 wt %. with the empirical formula of AlFₓ(OH)₆₋ₓ. The amount of fluorine loading can vary, and can be verified by x-ray fluorescence.

As used herein, “alpha-olefin” refers to organic compounds which are alkenes (also known as olefins) with a chemical formula CₓH₂ₓ, distinguished by having a double bond at the primary or alpha (α) position.

As used herein, “light component” refers to organic compounds having 2 to 8 carbon atoms (C2-C8).

As used herein, “paraffin” refers to an acyclic saturated hydrocarbon, i.e. an alkane consists of hydrogen and carbon atoms arranged in a tree structure in which all the carbon-carbon bonds are single.

As used herein, “C6-C8 aromatics” refer to a hydrocarbon with sigma bonds and delocalized pi electrons between carbon atoms forming a circle, wherein total of 6 to 8 carbon atoms are present.

As used herein, “onset temperature” or Tₒₙₛₑₜ refers to the temperature when first drop of liquid is observed in the heating process.

As used herein, “depolymerization half time” or “half time” is defined as the time required to achieve a 50% loss of the sample mass of the plastic at a certain temperature.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

The phrase “consisting of” is closed, and excludes all additional elements.

The phrase “consisting essentially of” excludes additional material elements, but allows the inclusions of non-material elements that do not substantially change the nature of the invention.

The following abbreviations are used herein:

| ABBREVIATION | TERM |
|---|---|
| HDPE | High density polyethylene |
| LDPE | Low density polyethylene |
| LLDPE | Linear low density polyethylene |
| PE | Polyethylene |
| PP | Polypropylene |
| PS | Polystyrene |
| TGA | Thermogravimetric analysis |

The disclosure provides a novel method for depolymerizing a feedstock comprising plastics in the presence of a fluorinated alumina catalyst, so as to facilitate the kinetics of depolymerization. Specifically, by using the fluorinated alumina catalyst in the depolymerizing process, the onset temperature can be reduced. Applicant further discovered that the reaction half time can also be reduced. The resulting products from the depolymerization by using the fluorinated catalyst have lower level of C9+ content and higher amount of C2-C8 components, indicating a more thorough depolymerization. All these improved results would lead to an improved plastic recycling process.

In one embodiment, a method of depolymerizing plastics comprising the steps of: introducing a feedstock comprising plastic; mixing the feedstock comprising plastic with a catalyst to obtain a reactant mixture; and heating the reactant mixture to obtain a product; wherein the catalyst is fluorinated alumina.

In one embodiment, the reactant mixture comprises 1-20 wt % of the catalyst. In another embodiment, the reactant mixture comprises 2-18 wt % of the catalyst. In another embodiment, the reactant mixture comprises 5-15 wt % of the catalyst. In yet another embodiment, the reactant mixture comprises 8-12 wt % of the catalyst.

In one embodiment, the feedstock comprising plastic is a mixture of polyolefins. In an embodiment, the feedstock comprising plastic contains at least 30 wt % polyolefins. In another embodiment, the feedstock comprising plastic contains at least 40 wt % polyolefins. In yet another embodiment, the feedstock comprising plastic contains at least 40 wt % plastic comprising HDPE, LLDPE, LDPE, PP, or mixtures thereof. In still another embodiment, at least 50 wt % of the feedstock comprising plastic comprises HDPE, LLDPE, LDPE, PP, or mixtures thereof. In another embodiment, at least 90 wt % of the feedstock comprising plastic comprises HDPE, LLDPE, LDPE, PP, or mixtures thereof.

In one embodiment, the onset temperature is reduced by 5% comparing to a liquid product obtained according to claim 1 without using the catalyst. In yet another embodiment, the onset temperature is reduced by at least 6% compared to a liquid product obtained according to claim 1 without using the catalyst. In yet another embodiment, the onset temperature is reduced by at least 7% compared to a liquid product obtained according to claim 1 without using the catalyst. In yet another embodiment, the onset temperature is reduced by at least 8% compared to a liquid product obtained according to claim 1 without using the catalyst. In yet another embodiment, the onset temperature is reduced by at least 10% compared to a liquid product obtained according to claim 1 without using the catalyst.

In one embodiment, the pressure in the reactor is maintained at at least 10 psi. In one embodiment, the pressure in the reactor is maintained at at least 15 psi. In one embodiment, the pressure in the reactor is maintained at at least 20 psi. In one embodiment, the pressure in the reactor is maintained at at least 25 psi. In one embodiment, the pressure in the reactor is maintained at at least 30 psi.

In one embodiment, the liquid product comprises 50% more light components (C2-C8) comparing to a liquid product obtained according to claim 1 without using the catalyst. In one embodiment, the liquid product comprises 60% more light components (C2-C8) comparing to a liquid product obtained according to claim 1 without using the catalyst. In one embodiment, the liquid product comprises 75% more light components (C2-C8) comparing to a liquid product obtained according to claim 1 without using the catalyst. In another embodiment, the liquid product comprises 100% more light components (C2-C8) comparing to a liquid product obtained according to claim 1 without using the catalyst.

The fluorinated alumina catalysts used in the embodiments were synthesized by the process described in Example 1. However, other fluorinated alumina are also possible, as long as similar catalytic activity is retained.

The plastic feedstock (or feedstock comprising plastic) used in this disclosure includes high-density polyethylene (HDPE), polypropylene (PP), and mixtures thereof. However, other plastic feedstock may also be depolymerized, including but not limited to other polyolefins like low-density polyethylene (LDPE), linear low density polyethylene (LLDPE), polybutene, ethylene-propylene copolymers. The feedstock can also include polymeric mixtures that incorporates other materials like polystyrene (PS), ethyl-vinyl acetate copolymer (EVA), ethyl-vinyl alcohol copolymer (EVOH), polyvinyl chloride (PVC), or mixtures thereof.

In one embodiment, the plastic feedstock is first melt-compounded with the fluorinated alumina catalyst in an extruder, for example in a HAAKE MiniCTW compounder at 200° C. and 200 RPM for 5 minutes, to result in a uniform reactant mixture. Other types of extruder or compounder, as well as different extrusion conditions can also be used.

In an alternative embodiment the catalyst can also be delivered separately into the reaction zone or fed into the reactor as a mechanical mixture with solid polymer feed.

The amount of the fluorinated alumina catalyst in the plastic/catalyst reactant mixture can vary, depending on the type of feedstock and the energy consumption plan. In one embodiment, the amount of fluorinated alumina catalyst used is 1 wt % to 20 wt % of the total reactant mixture. In an alternative embodiment, the amount of catalyst used is 2 wt % to 18 wt %, or 5 wt % to 15 wt % of the total reactant mixture.

The plastic feedstock and the reactant mixture (with the fluorinated alumina catalyst) then underwent TGA to determine their depolymerization rate. The reactant mixture also underwent general depolymerization to determine the onset temperature, yield of liquid condensable, and yield of solid residue. The liquid condensable portion is also further characterized to determine the effect of using the fluorinated alumina catalyst.

### Thermogravimetric Analysis (TGA)

TGA is a convenient technique to study thermal and thermo-catalytic delopymerization processes. The plastic feedstock and the reactant mixture are tested in thermogravimetric analysis (TGA) to determine sample depolymerization rate. In a typical configuration, the starting temperature is 25-100° C. and the heating rate is 10° C./min, but other configuration can also be adopted. Polymer samples were heated under N₂ at 10K/min to the desired depolymerization temperature in a Mettler Toledo TGA/DSC 3+and held for 1 hour. However, the choice of inert gas, the amount of inert gas, and the heating temperature and length of the depolymerization may be modified depending on the plastic feedstock and amount of the fluorinated alumina catalyst used.

The depolymerization half time at a specific temperature, defined as the time required to achieve a 50% loss of sample mass, was recorded directly if the value is less than 60 min or determined under the assumption of a first order decomposition kinetics as t_{1/2}=0.693/k, where k is the first order rate constant determined graphically using a Ln(Co/C) vs time plot.

### General Depolymerization

A 20 g polymer sample along with catalyst in a closed 125 ml Parr reactor at 11 psi pressure and constant N₂ flow of 100 sccm (standard cubic centimeter per minute) was placed in the hot zone of a furnace preheated to 650° C. The evolving vapors leaving the reactor were condensed in an ice trap. The following process parameters were recorded and used to characterize the depolymerization efficiency:
Tₒₙₛₑₜ: temperature of reaction mixture when condensation of liquid product is first observed.
L%: yield of liquid condensable in an ice trap.
S%: yield of solid residue in the reactor, excluding catalyst.

After the depolymerization step, when liquid formation had ceased, the resulting liquid product is characterized using gas chromatography, simulated distillation, ¹H NMR and gel permeation chromatography (GPC), to determine the types of chemicals, the amount of each, and the molecular weight/molecular weight distribution thereof.

### Gas Chromatography

Liquid product samples collected at the depolymerization step were characterized by gas chromatography using an Agilent 7890 equipped with a non-polar column and FID with the following distribution.
C2-C4s (wt %)
C5s (wt %)
C6s (wt %)
C7s (wt %)
C8s (wt %)
C9 and heavier (wt %)
Linear α-olefines (wt %)
n-paraffins (wt %)
C6-C8 Aromatics (with co-elutions) (wt %)

### Simulated Distillation

Simulated distillation (SimDist) is used to quickly and accurately determine the true boiling point distribution of crude oil and petroleum refining fractions by gas chromatography. The sample is first injected into the GC, and the analytical column separates the sample into individual components in order of their boiling points. The components are detected as they elute from the column, and a software is used to convert the data produced by the GC into a report that includes the boiling curve, initial boiling point (IBP), boiling points in 5% increments from 5% off to 95%, final boiling point (FBP, 99.5% off), % cutoff table, etc. The simulated distillation (SimDist) data for the liquid samples were collected using ASTM D7213 on an Agilent 6980.

### ¹H NMR

NMR data were collected on a Bruker AV500 MHz NMR spectrometer at 25° C. with a 5 mm Prodigy probe. 1D ¹H NMR data were processed using TOPSPIN software with an exponential line broadening window function. Quantitative measurements utilized a 15 second relaxation delay, 30 degree flip angle pulse, and 32 scans to facilitate accurate integrals. Spectral integrations was used for aromatic olefinic, and paraffinic protons were obtained and used to quantify relative ratios of these protons. All samples were analyzed with an addition of CDCl₃ (0.6 g of sample with 0.4 g of CDCl₃). ¹H NMR data used for liquid characterization includes:
% Aromatic Proton
% Paraffinic Proton
% Olefinic Proton

Below are the conditions of examples and comparative examples.

### Example of Synthesis of Fluorinated Alumina

The fluorinated alumina as catalyst used herein was synthesized through the following procedure: a solution of 2 g of ammonium fluoride in 20 ml of deionized water was added to a 20 g sample of commercial sample of Al₂O₃ (gamma, weakly acidic, SigmaAldrich) and the resulting wet cake was evenly spread on a ceramic calcination dish. After drying for 2 hours at 110° C., the sample was calcined for 6 hours at 450° C.

### EXAMPLE 1

### TGA Depolymerization Rate of PP With Catalyst

The depolymerization half time for a Polypropylene sample (grade HP522, a LyondellBasell product) mixed with 10 wt % of a catalyst sample prepared according to Example of Synthesis was 15 minutes at 400° C., which was two times faster than that observed in the comparative example 1 below. The results demonstrated the effect of the fluorinated alumina on depolymerization rate.

### EXAMPLE 2

### TGA Depolymerization Rate of PP/HDPE With Catalyst

The depolymerization half time for a sample consisting of a 1:1 mixture of HDPE (ACP9255 grade, a LyondellBasell product) and Polypropylene (grade HP522, a LyondellBasell product) mixed with 10 wt % of a catalyst sample prepared according to Example of Synthesis was 22 minutes at 400° C., which was four times faster than that observed in the comparative example 2 below. The results demonstrated the effect of the fluorinated alumina on depolymerization rate that is higher with a mixture of polyolefins.

### COMPARATIVE EXAMPLE 1

### TGA Depolymerization Rate of PP Without Catalyst

The depolymerization half time for a Polypropylene sample (grade HP522, a LyondellBasell product) was 35 minutes at 400° C. without using any catalyst.

### COMPARATIVE EXAMPLE 2

### TGA Depolymerization Rate of PP/HDPE Without Catalyst

The depolymerization half time for a sample consisting of a 1:1 mixture of HDPE (ACP9255 grade, a LyondellBasell product) and Polypropylene (grade HP522, a LyondellBasell product) was 96 minutes at 400° C.

### EXAMPLE 3

### Depolymerization (10 wt % Catalyst to PP/HDPE)

20 g of a polymer sample consisting of a 1:1 mixture of HDPE (ACP9255 grade, a LyondellBasell product) and Polypropylene (grade HP522, a LyondellBasell product) mixed with a 10% catalyst sample prepared according to Example of Synthesis was depolymerized, resulting in a clear yellow liquid. Process parameters and liquid properties are summarized in Table 1 and FIG. 1.

The presence of olefinic groups is reduced in the catalytic liquids according to 1H NMR compared to the non-catalyzed liquid.

### COMPARATIVE EXAMPLE 3

### Depolymerization of PP/HDPE Without Catalyst

20 g of a polymer sample consisting of a 1:1 mixture of HDPE (ACP9255 grade, a LyondellBasell product) and Polypropylene (grade HP522, a LyondellBasell product) was depolymerized without catalyst resulting in waxy liquid.

Process parameters and liquid properties as characterized by GC, NMR and GPC are summarized in Table 1 for Example 3 and Comparative Example 3.

TABLE 1
EFFECT OF FLUORINATED ALUMINA ON PP/HDPE

| Process Parameter/ | | |
|---|---|---|
| Liquid Property | Comp. Ex. 3 | Ex. 3 |
| Tₒₙₛₑₜ, ° C. | 430 | 352 |
| L %, % | 88.9 | 89.2 |
| S %, % | <1 | <1 |

GC Data

| | | |
|---|---|---|
| C2-C4s, % | 1.09 | 5.61 |
| C5s, % | 4.54 | 10.99 |
| C6s, % | 5.66 | 12.31 |
| C7s, % | 3.29 | 13.60 |
| C8s, % | 5.72 | 13.22 |
| C9s and heavier, % | 79.70 | 44.26 |
| α-olefins, % | 18.17 | 5.25 |
| n-paraffins, % | 23.25 | 5.47 |
| C6-C8 aromatics, % | 0.78 | 1.73 |

NMR Date

| | | |
|---|---|---|
| Aromatic 1H, % | 0.12 | 0.13 |
| Paraffinic 1H, % | 92.84 | 93.52 |
| Olefinic 1H, % | 7.04 | 6.34 |

As shown in Table 1, comparison of the results of this Example 3 with Comparative Example 3 shows that the presence of the catalyst resulted in reduction of depolymerization onset temperature, from 430° C. to 352° C. Liquids yield is also increased from 88.9% to 89.2% in the presence of the catalyst. The GC data shows that with the catalyst, the levels of light components C2-C8 were increased compared to C9+molecules (C2-C4: 1.09% to 5.61%; C5s: 4.54% to 10.99%; C6s: 5.66% to 12.31%; C7s: 3.29% to 13.60%; C8s: 5.72% to 13.22%; C9+: 79.70% to 44.26%). The amount of linear alpha olefins and n-paraffins in the liquid generated in the presence of the catalyst was comparable.

### Additional Disclosure

The particular embodiments disclosed above are merely illustrative, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and such variations are considered within the scope and spirit of the present disclosure. Alternative embodiments that result from combining, integrating, and/or omitting features of the embodiment(s) are also within the scope of the disclosure. Use of the term “optionally” with respect to any element of a claim means that the element is present, or alternatively, the element is not present, both alternatives being within the scope of the claim.

Numbers and ranges disclosed above may vary by some amount. Whenever a numerical range with a lower limit and an upper limit is disclosed, any number and any included range falling within the range is specifically disclosed. In particular, each range of values (of the form, “from about a to about b,” or, equivalently, “from approximately a to b,” or, equivalently, “from approximately a-b”) disclosed herein is to be understood to set forth each number and range encompassed within the broader range of values. Also, the terms in the claims have their plain, ordinary meaning unless otherwise explicitly and unambiguously defined by the patentee. If there is any conflict in the usages of a word or term in this specification and one or more patent or other documents, the definitions that are consistent with this specification should be adopted.

Embodiments disclosed herein include:

A: A method of depolymerizing plastics, comprising the steps of: introducing a reactant mixture into a reactor, the reactant mixture comprising a feedstock comprising plastic and a catalyst comprising a halogenated alumina; and heating the reactant mixture for a sufficient duration and at a sufficient temperature so as to cause the plastic to depolymerize thereby forming a product.

Embodiment A may include one or more of the following elements:

Element 1: wherein the reactant mixture is formed within the reactor by mixing the feedstock comprising plastic with the catalyst comprising a halogenated alumina inside the reactor.

Element 2: wherein the reactant mixture comprises 1-20 wt % of the catalyst comprising a halogenated alumina. Element 3: wherein the reactant mixture comprises 6-12 wt % of the catalyst comprising a halogenated alumina. Element 4: wherein the reactant mixture comprises 4-8 wt % of the catalyst comprising a halogenated alumina. Element 5: wherein the reactant mixture comprises 8-14 wt % of the catalyst comprising a halogenated alumina. Element 6: wherein the reactant mixture comprises 10-20 wt % of the catalyst comprising a halogenated alumina. Element 7: wherein the halogenated alumina is a fluorinated alumina. Element 8: wherein the feedstock comprising plastic comprises a polyolefin. Element 9: wherein the feedstock comprising plastic comprises at least 10 wt % of one or more of: HDPE, LLDPE, LDPE, PP, or mixtures thereof. Element 10: wherein the feedstock comprising plastic comprises at least 25 wt % of one or more of: HDPE, LLDPE, LDPE, PP, or mixtures thereof. Element 11: wherein the feedstock comprising plastic comprises at least 40 wt % of one or more of: HDPE, LLDPE, LDPE, PP, or mixtures thereof. Element 12: wherein the feedstock comprising plastic comprises at least 50 wt % of one or more of: HDPE, LLDPE, LDPE, PP, or mixtures thereof. Element 13: wherein the feedstock comprising plastic comprises at least 65 wt % of one or more of: HDPE, LLDPE, LDPE, PP, or mixtures thereof. Element 14: wherein the feedstock comprising plastic comprises at least 80 wt % of one or more of: HDPE, LLDPE, LDPE, PP, or mixtures thereof. Element 15: wherein the product is a liquid. Element 16: wherein the liquid product comprises at least 25% more light components (C2-C8) compared to a liquid product obtained under similar processing conditions but without using the catalyst. Element 17: wherein the liquid product comprises at least 33% more light components (C2-C8) compared to a liquid product obtained under similar processing conditions but without using the catalyst. Element 18: wherein the liquid product comprises at least 50% more light components (C2-C8) compared to a liquid product obtained under similar processing conditions but without using the catalyst. Element 19: wherein the liquid product comprises at least 75% more light components (C2-C8) compared to a liquid product obtained under similar processing conditions but without using the catalyst. Element 20: wherein the liquid product comprises at least 100% more light components (C2-C8) compared to a liquid product obtained under similar processing conditions but without using the catalyst. Element 21: wherein a depolymerization onset temperature is reduced by at least 3% compared to a liquid product obtained under similar processing conditions but without using the catalyst. Element 22: wherein a depolymerization onset temperature is reduced by at least 5% compared to a liquid product obtained under similar processing conditions but without using the catalyst. Element 23: wherein a depolymerization onset temperature is reduced by at least 8% compared to a liquid product obtained under similar processing conditions but without using the catalyst. Element 24: wherein a depolymerization onset temperature is reduced by at least 10% compared to a liquid product obtained under similar processing conditions but without using the catalyst. Element 25: wherein during the heating the reactor is maintained at at least 10 psig. Element 26: wherein during the heating the reactor is maintained at at least 15 psig. Element 27: wherein during the heating the reactor is maintained at at least 30 psig. Element 28: wherein the reactant mixture is premade before being introduced into the reactor.

While certain embodiments have been shown and described, modifications thereof can be made by one skilled in the art without departing from the teachings of this disclosure. Numerous other modifications, equivalents, and alternatives, will become apparent to those skilled in the art once the above disclosure is fully appreciated. It is intended that the following claims be interpreted to embrace such modifications, equivalents, and alternatives where applicable.

Accordingly, the scope of protection is not limited by the description set out above but is only limited by the claims which follow, that scope including equivalents of the subject matter of the claims.

What is claimed is:

1. A method of depolymerizing plastics, comprising the steps of:
introducing a reactant mixture into a reactor, the reactant mixture comprising a feedstock comprising plastic and a catalyst comprising a halogenated alumina;
heating the reactant mixture so as to cause the plastic to depolymerize thereby forming a product.

2. The method of claim 1 wherein the reactant mixture is formed within the reactor by mixing the feedstock comprising plastic with the catalyst comprising a halogenated alumina inside the reactor.

3. The method of claim 1 wherein the reactant mixture comprises 1-20 wt % of the catalyst comprising a halogenated alumina.

4. The method of claim 1 wherein the reactant mixture comprises 6-12 wt % of the catalyst comprising a halogenated alumina.

5. The method of claim 1 wherein the halogenated alumina is a fluorinated alumina.

6. The method of claim 1 wherein the feedstock comprising plastic comprises a polyolefin. The method of claim 1 wherein the feedstock comprising plastic comprises at least 10 wt % of one or more of: HDPE, LLDPE, LDPE, PP, or mixtures thereof.

8. The method of claim 1 wherein the feedstock comprising plastic comprises at least 25 wt % of one or more of: HDPE, LLDPE, LDPE, PP, or mixtures thereof.

9. The method of claim 1 wherein the feedstock comprising plastic comprises at least 40 wt % of one or more of: HDPE, LLDPE, LDPE, PP, or mixtures thereof.

10. The method of claim XX wherein the feedstock comprising plastic comprises at least 50 wt % of one or more of: HDPE, LLDPE, LDPE, PP, or mixtures thereof.

11. The method of claim 1 wherein the feedstock comprising plastic comprises at least 65 wt % of one or more of: HDPE, LLDPE, LDPE, PP, or mixtures thereof.

12. The method of claim 1 wherein the feedstock comprising plastic comprises at least 80 wt % of one or more of: HDPE, LLDPE, LDPE, PP, or mixtures thereof.

13. The method of claim 1 wherein the product is a liquid.

14. The method of claim 13 wherein the liquid product comprises at least 50% more light components (C2-C8) compared to a liquid product obtained according to claim 1 at similar processing conditions but without using the catalyst.

15. The method of claim 13 wherein the liquid product comprises at least 100% more light components (C2-C8) compared to a liquid product obtained according to claim 1 at similar processing conditions but without using the catalyst.

16. The method of claim 1 wherein a depolymerization onset temperature is reduced by at least 3% compared to a liquid product obtained according to claim 1 at similar processing conditions but without using the catalyst.

17. The method of claim 1 wherein a depolymerization onset temperature is reduced by at least 10% compared to a liquid product obtained according to claim 1 at similar processing conditions but without using the catalyst.

18. The method of claim 1, wherein during the heating the reactor is maintained at at least 10 psig.
